(19) United States
(12) Patent Application Publication
(10) Pub. No.: US 2020/0370709 A1
(43) Pub. Date: Nov. 26, 2020

(54) DEVICE AND METHOD FOR PROVIDING LIQUEFIED NATURAL GAS

(71) Applicant: ENGIE, Courbevoie (FR)

(72) Inventors: Hicham GUEDACHA, Courbevoie (FR); Hugues MALVOS, Courbevoie (FR); Yacine ZELLOUF, Courbevoie (FR)

(21) Appl. No.: 16/766,714

(22) PCT Filed: Nov. 22, 2018
(86) PCT No.: PCT/FR2018/052957

§ 371 Date: May 27, 2020

(30) Foreign Application Priority Data
Nov. 24, 2017 (FR) 1761146

(51) Int. Cl. F17C 7/02; F17C 13/04; F17C 13/02

(52) U.S. Cl. CPC F17C 7/02; F17C 2270/0168; F17C 13/025; F17C 13/026; F17C 2221/033; F17C 2227/0157; F17C 2205/0352; F17C 2223/0169; F17C 2250/043; F17C 2205/0326; F17C 2250/0439; F17C 2227/0306; F17C 2227/0135; F17C 2227/0388; F17C 2265/065; F17C 13/04

(57) ABSTRACT

The device (100) for providing liquefied natural gas, referred to as LNG, comprises:
an evaporation gas buffer tank (105) comprising an inlet (110) for evaporation gas suitable for receiving evaporation gas from a third-party device,
a member (115) for transferring evaporation gas from the buffer tank to an LNG storage capacity (120),
downstream from the transfer member (120), a compressor (140) for compressing the evaporation gas,
an evaporation gas transfer pipe (125) for transferring evaporation gas from the transfer member to the storage capacity,
the LNG storage capacity,
an LNG transfer pipe (130) for transferring LNG from the storage capacity to a third-party device and
a heat exchanger (135) for exchanging heat between evaporation gas passing through the evaporation gas transfer pipe and LNG passing through the LNG transfer pipe configured to liquefy or cool the evaporation gas.

### TECHNICAL FIELD OF THE INVENTION

The present invention relates to a device and method for providing liquefied natural gas. It applies, in particular, to the field of the provision of LNG suitable for land- and sea-going vessels.

### STATE OF THE ART

The use of liquefied natural gas (hereinafter “LNG”) as a road or marine fuel is expanding rapidly, boosted by the environmental and economic advantages that LNG offers compared to other fossil fuels.

In general, LNG service stations consist of an LNG receiving system, cryogenic storage allowing the LNG to be stored in a subcooled state at an operating pressure generally between 7 and 9 bar, a cryogenic pump enabling the LNG to be transferred, and a distribution system for fueling the vehicle.

Today, three categories of vehicles are likely to be refueled with LNG:
a first category is fueled with cold LNG, i.e. having a pressure of 3 bar;
a second category is fueled with saturated LNG, having a pressure of 8 bar; and
a third category is fueled with super saturated LNG, having a pressure of 18 bar.

Currently, most vehicles have a pressure of 8 bar. There is relatively significant LNG vaporization, creating BOG (Boil-off gas), during the refueling of 8- and 18-bar vehicles. Vehicle tanks have been sized to withstand rises in pressure, but the design of this equipment is nevertheless restricted by a maximum allowable pressure.

Thus, to prevent this maximum pressure being reached there is a return of gas from the vehicle to the station, leading to a significant release of gas into the atmosphere.

This gas returned to the LNG storage is a source of heat for the LNG, boosting LNG evaporation and therefore increasing the pressure in the storage. These evaporations or BOGs must be managed without being released into the atmosphere.

As well as the product losses incurred, this adds to the site's operational complexity.

Furthermore, the LNG stored in the service station's storage tank is generally in a subcooled state. The heat source allowing the LNG to be brought to saturation (8 bar and 18 bar) comes from the open air, requiring the installation of a substantial exchanger surface on site.

In addition, there are two methods of providing LNG fuel for 8- and 18-bar vehicles:
the bulk saturation method, which consists of storing the LNG at saturation; and
a method consisting of using an ‘LNG saturation on the fly’ module designed to provide LNG at saturation from subcooled LNG.

With regard to compressed LNG (CLNG) service stations, storage of the returned gas in a buffer tank for CNG use is known. Some LNG stations accept the returned gas and are not concerned about its impact on the generation of BOG. These stations are generally equipped with a BOG liquefaction system.

The current solutions use air vaporizers to obtain saturated LNG, requiring very large exchange surfaces and a significant footprint.

The “saturation on the fly” systems have the drawbacks of requiring very efficient, but costly, exchangers, and needing a very complex control system, which poses the problem of operational stability.

Lastly, the bulk saturation systems cannot fuel vehicles operating at a pressure of 3 bar, and have reduced storage capacity and storage time.

It should be noted that, in the case of stations equipped with BOG liquefaction systems, these systems are expensive and have no potential return on investment.

### SUBJECT OF THE INVENTION

The present invention aims to remedy all or part of these drawbacks.

To this end, according to a first aspect, the present invention envisages a device for providing liquefied natural gas, referred to as LNG, which comprises:
a buffer tank for evaporation gas, comprising an inlet for evaporation gas suitable for receiving evaporation gas from a third-party device;
a transfer member for transferring evaporation gas from the buffer tank to an LNG storage capacity;
downstream from the transfer member, a compressor for compressing the evaporation gas;
an evaporation gas transfer pipe for transferring evaporation gas from the transfer member to the storage capacity;
the LNG storage capacity;
an LNG transfer pipe for transferring LNG from the storage capacity to a third-party device; and
a heat exchanger for exchanging heat between evaporation gas passing through the evaporation gas transfer pipe and LNG passing through the LNG transfer pipe, configured to liquefy or cool the evaporation gas.

Thanks to these provisions, the evaporation gas transferred from the buffer tank to the storage capacity is liquefied, which enables the LNG stored in the capacity to be kept at a low temperature, reducing the formation of BOG in this capacity.

These provisions also improve the performance of the device in terms of liquefaction of the evaporation gas.

In some embodiments, the transfer member is a valve controlled as a function of a value of the pressure inside the buffer tank measured by a pressure sensor, or a discharge device.

In some embodiments, the evaporation gas and the LNG circulate in opposite directions inside the heat exchanger.

These embodiments improve the performance of the device in terms of liquefaction of the evaporation gas.

In some embodiments, the buffer tank has an operating pressure value at least two bar greater than the operating pressure value of the storage capacity.

These embodiments allow the evaporation gas to flow naturally from the buffer tank to the storage capacity.

In some embodiments, the device that is the subject of the present invention comprises, downstream from the heat exchanger, a bypass of the transfer pipe for liquefied or cooled evaporation gas in the heat exchanger, the provision of evaporation gas to the bypass being controlled as a function of a temperature measured by a temperature sensor for the evaporation gas on exit from the heat exchanger.

These embodiments allow evaporation gas that has not reached a defined temperature value to be recycled.

In some embodiments, the device that is the subject of the present invention comprises a first valve on the bypass and a second valve on the evaporation gas transfer pipe downstream from the bypass, the opening of the first or second valve being controlled as a function of the evaporation gas temperature measured.

These embodiments allow evaporation gas that has not reached a defined temperature value to be recycled.

In some embodiments, the device that is the subject of the present invention comprises a member for transferring liquefied evaporation gas from the buffer tank to the LNG transfer pipe.

These embodiments make it possible to saturate the LNG transferred to the third-party device.

In some embodiments, the device that is the subject of the present invention comprises:
an extraction line for extracting evaporation gas inside the storage capacity;
a compressor for compressing evaporation gas passing through the extraction line; and
a supply line for supplying compressed evaporation gas to the buffer tank.

These embodiments allow the storage volume required by the buffer tank to be minimized.

In some embodiments, the evaporation gas compressor comprises the inlet for evaporation gas suitable for receiving evaporation gas from a third-party device.

In some embodiments, the device that is the subject of the present invention comprises a means for cooling the evaporation gas flow downstream from the transfer member.

These embodiments make it possible to partially or fully cool or liquefy an evaporation gas flow on exit from the heat exchanger.

In some embodiments, the device that is the subject of the present invention comprises, downstream from the heat exchanger, a regulator for the gaseous flow, configured to expand the liquefied natural gas to a defined pressure.

In some embodiments, the device that is the subject of the present invention comprises, downstream from the regulator, a gas/liquid separator, the gaseous evaporation gas being supplied to the bypass and the liquid evaporation gas being supplied to the storage capacity.

According to a second aspect, the present invention envisages a method for providing liquefied natural gas, referred to as LNG, which comprises:
a step of storing evaporation gas from a third-party device in an evaporation gas buffer tank comprising an evaporation gas inlet suitable for receiving evaporation gas from a third-party device;
a step of transferring evaporation gas from the buffer tank to an LNG storage capacity;
downstream from the transfer step, a step of compressing the evaporation gas;
a step of exchanging heat between the transferred evaporation gas and the LNG transferred to a third-party device from the LNG storage capacity in order to liquefy or cool the evaporation gas;
a step of storing LNG in the storage capacity;
a step of transferring LNG from the storage capacity to a third-party device.

As the particular aims, advantages and features of the method that is the subject of the present invention are similar to those of the device that is the subject of the present invention, they are not repeated here.

### BRIEF DESCRIPTION OF THE FIGURES

Other advantages, aims and particular features of the invention will become apparent from the non-limiting description that follows of at least one particular embodiment of the device and method that are the subjects of the present invention, with reference to drawings included in an appendix, wherein:

FIG. 1 represents, schematically, a first particular embodiment of the device that is the subject of the present invention;

FIG. 2 represents, schematically and in the form of a logical diagram, a particular series of steps of the method that is the subject of the present invention; and

FIG. 3 represents, schematically, a second particular embodiment of the device that is the subject of the present invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

Subsequently, “third-party device” will refer to any device using LNG to produce energy. Such a third-party device is, for example, a land, sea, river or air vehicle.

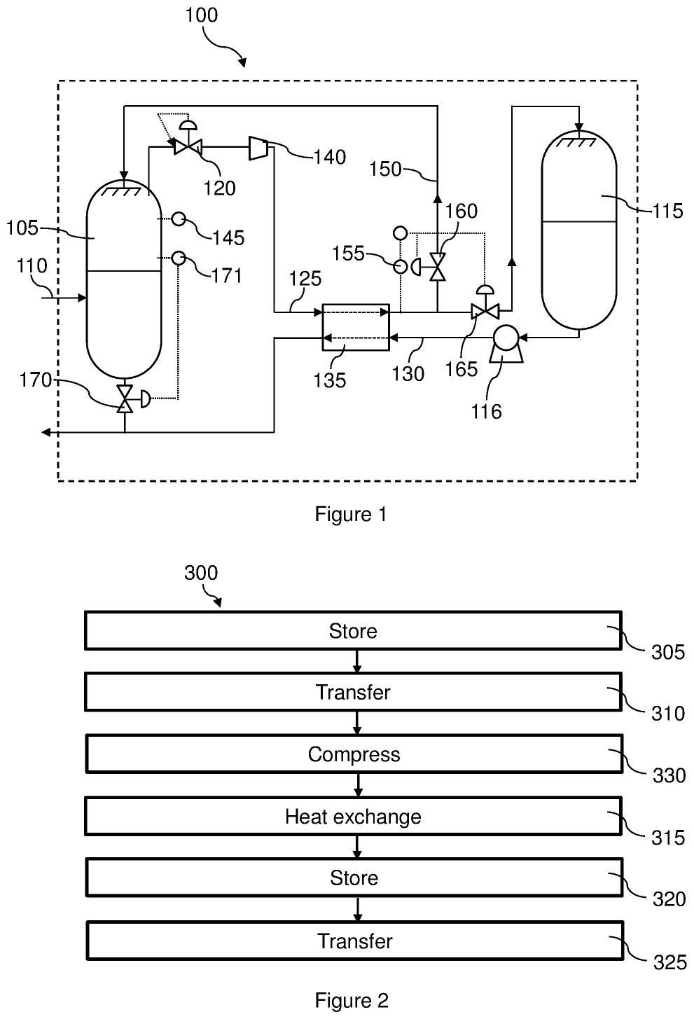

FIG. 1, which is not to scale, shows a schematic view of an embodiment of the device 100 that is the subject of the present invention. This device 100 for providing liquefied natural gas, referred to as LNG, comprises:
an evaporation gas buffer tank 105 comprising an inlet 110 for evaporation gas suitable for receiving evaporation gas from a third-party device;
a member 120 for transferring evaporation gas from the buffer tank to an LNG storage capacity 115;
an evaporation gas transfer pipe 125 for transferring evaporation gas from the transfer member to the storage capacity;
the LNG storage capacity;
an LNG transfer pipe 130 for transferring LNG from the storage capacity to a third-party device; and
a heat exchanger 135 for exchanging heat between evaporation gas passing through the evaporation gas transfer pipe and LNG passing through the LNG transfer pipe, configured to liquefy or cool the evaporation gas.

The tank 105 is, for example, an evaporation gas storage volume designed to hold a predefined amount of evaporation gas in a defined pressure range. The inlet 110 is, for example, a hole made in the storage volume and configured to receive an injector for injecting evaporation gas into the volume. Such an injector is, for example, a nozzle or a one-way valve.

This tank 105 is configured, for example, to operate at an operating pressure greater than 11 bar.

This tank 105 has, for example, a one cubic meter capacity, and the capacity 115 has, for example, an eighty cubic meters capacity.

The inlet 110 is preferably linked to a connector with the third-party device configured to collect the evaporation gas returned. The type of connector depends on the standard used by the third-party device and the envisaged purpose of the device 100.

The evaporation gas is supplied from the third-party device to the tank 105, for example, by means of the pressure gradient.

This tank 105 is equipped, preferably in the upper portion, with an evaporation gas outlet linked to the transfer member 115. The transfer member 115 is, for example, a discharge device or a valve controlled as a function of a pressure value measured inside the tank 105. This pressure value is measured, for example, by a pressure sensor 145. When the measured pressure is above a setpoint value, the valve is opened.

The choice of this setpoint value is arbitrary, and is set by the operator. It depends on the design and cost objectives of the station. For example, a setpoint pressure of 15 or 16 bar can be utilized if the station is sized to supply vehicles operating at 18 bar.

The gas transfer pipe 125 links the transfer member 115 to the storage capacity 115. Preferably, the device 100 comprises, downstream from the transfer member 120, a compressor 140 or a booster.

Such a compressor 140 is, for example, a reciprocating compressor, preferably a reciprocating piston compressor type.

On exit from the compressor 140 or booster, the gas has sufficient pressure to overcome the load losses of the circuit and enable recycling to be realized. The choice of discharge pressure is set as a function of sizing objectives for the station and of the operating mode desired by the operator.

The evaporation gas, compressed or not by the compressor 140 according to the presence of the compressor 140 in the device 100, passes through the heat exchanger 135.

The heat exchanger 135 is, for example, a finned or plate exchanger exchanging heat between the evaporation gas passing through the transfer pipe 125 and the LNG passing through the transfer pipe 130. The evaporation gas acts as hot fluid and the LNG as cold fluid, such that the outlet evaporation gas temperature is lower than the inlet evaporation gas temperature in the heat exchanger 135. Preferably, the heat exchanger 135 is designed such that the evaporation gas is liquefied or cooled on exit from the heat exchanger 135 for defined LNG and evaporation gas flow rates.

The heat exchanger 135 is also designed, preferably, to heat the LNG to a defined temperature. The flow rate of gas passing through the transfer pipe 125 is adjusted as a function of said temperature. If the temperature of the LNG has to be raised, the gas transfer flow rate in the pipe 125 is increased.

Preferably, the LNG and evaporation gas circulate in opposite directions so as to optimize the heat exchange between the two fluids.

The storage capacity 115 is, for example, an evaporation gas storage volume designed to hold a predefined amount of LNG in a defined pressure range. The capacity 115 preferably comprises an inlet for liquefied evaporation gas. This inlet is, for example, a hole made in the storage capacity and configured to receive an injector for injecting liquefied evaporation gas into the volume. Such an injector is, for example, a nozzle or a one-way valve.

The capacity 115 is configured to operate, for example, at a pressure of 7 to 9 bar.

Preferably, the operating pressure inside the storage capacity 115 is at least two bar less than the operating pressure inside the buffer tank 105.

The capacity 115 is equipped with an outlet for LNG, preferably in the lower portion, linked to the transfer pipe 130.

The transfer pipe 130 is linked to a connector whose nature depends on the type of third-party device connected to the device 100.

In some variants, the device 100 comprises a pump 116 configured to facilitate the transfer of LNG from the capacity 115 to the third-party device.

In some preferred embodiments, such as that shown in FIG. 1, the device 100 comprises, downstream from the heat exchanger 135, a bypass 150 of the transfer pipe 125 for liquefied or cooled evaporation gas in the heat exchanger, the provision of evaporation gas to the bypass being controlled as a function of a temperature measured by a temperature sensor 155 for the evaporation gas on exit from the heat exchanger.

In some preferred embodiments, such as that shown in FIG. 1, the device 100 comprises a first valve 160 on the bypass 150 and a second valve 165 on the evaporation gas transfer pipe 125 downstream from the bypass, the opening of the first or second valve being controlled as a function of the evaporation gas temperature measured.

When the evaporation gas has a temperature below a predefined threshold temperature, the first valve 160 is open and the second valve 165 is closed. Conversely, when the evaporation gas has a temperature above the predefined threshold temperature, the first valve 160 is closed and the second valve 165 is open.

In some preferred embodiments, such as that shown in FIG. 1, the device 100 comprises a member 170 for transferring liquefied evaporation gas from the buffer tank 105 to the LNG transfer pipe 130.

The member 170 is, for example, a valve controlled as a function of the pressure measured inside the storage tank 105 by a pressure sensor 171.

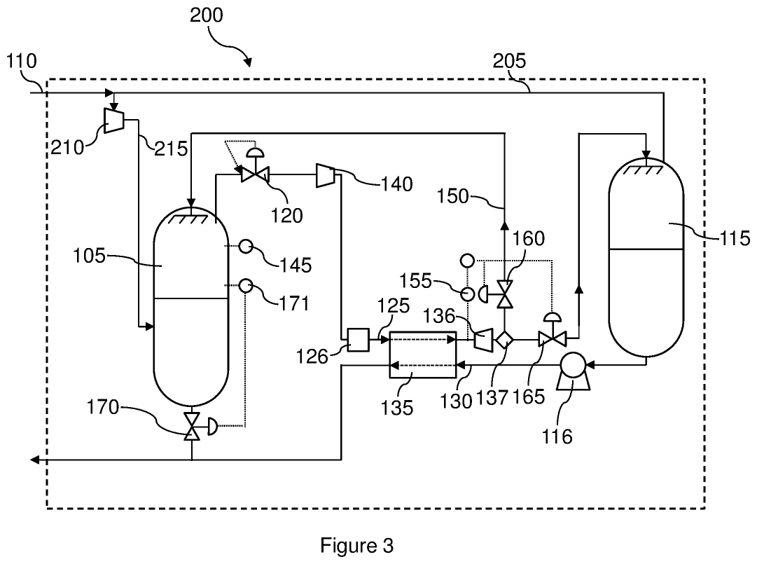

FIG. 3, which is not to scale, shows a schematic view of an embodiment of the device 200 that is the subject of the present invention. This device 200 for providing liquefied natural gas, referred to as LNG, comprises:

an evaporation gas buffer tank 105 comprising an inlet 110 for evaporation gas suitable for receiving evaporation gas from a third-party device;
a member 115 for transferring evaporation gas from the buffer tank to an LNG storage capacity 120;
downstream from the transfer member 120, a compressor 140 for compressing the evaporation gas;
an evaporation gas transfer pipe 125 for transferring evaporation gas from the transfer member to the storage capacity;
the LNG storage capacity;
an LNG transfer pipe 130 for transferring LNG from the storage capacity to a third-party device; and
a heat exchanger 135 for exchanging heat between evaporation gas passing through the evaporation gas transfer pipe and LNG passing through the LNG transfer pipe, configured to liquefy or cool the evaporation gas.

The tank 105 is, for example, an evaporation gas storage volume designed to hold a predefined amount of evaporation gas in a defined pressure range. The inlet 110 is, for example, a hole made in the storage volume and configured to receive an injector for injecting evaporation gas into the volume. Such an injector is, for example, a nozzle or a one-way valve.

The tank 105 is, for example, configured to operate at an operating pressure greater than 30 bar.

This tank 105 has, for example, a one cubic meter capacity, and the capacity 115 has, for example, an eighty cubic meters capacity.

The inlet 110 is preferably linked to a connector with the third-party device configured to collect the evaporation gas returned. The type of connector depends on the standard used by the third-party device and the envisaged purpose of the device 200.

The evaporation gas is supplied from the third-party device to the tank 105, for example, by means of the pressure gradient, or thanks to the use of a booster.

This tank 105 is equipped, preferably in the upper portion, with an evaporation gas outlet linked to the transfer member 115. The transfer member 115 is, for example, a discharge device or a valve controlled as a function of a pressure value measured inside the tank 105. This pressure value is measured, for example, by a pressure sensor 145. When the measured pressure is above a setpoint value, the valve is opened.

The setpoint value is chosen, for example, to correspond to the maximum operating pressure of the capacity 105. Note that the operator can also permit the transfer of gas remotely without this maximum pressure being reached, if necessary, by a second on-off valve, for example.

The gas transfer pipe 125 links the transfer member 115 to the storage capacity 115. Preferably, the device 200 comprises, downstream from the transfer member 120, a compressor 140.

On exit from the compressor 140 the gas has, for example, a pressure greater than or equal to 50 bar.

The evaporation gas, compressed or not by the compressor 140 according to the presence of the compressor 140 in the device 200, passes through the heat exchanger 135.

In some embodiments, such as that shown in FIG. 3, the device 200 comprises a means 126 for cooling the evaporation gas flow downstream from the transfer member 120. This cooling means 126 is, for example, a heat exchanger utilizing liquid nitrogen as cold fluid. On exit from the heat exchanger 135, the evaporation gas flow is preferably two-phase, i.e. partially liquid and partially gaseous, or more generally cooled. This flow can be injected into the storage capacity 115.

In some embodiments, such as that shown in FIG. 3, the device 200 comprises, downstream from the heat exchanger 135, a regulator 136 for the gaseous flow, configured to expand the liquefied natural gas to a defined pressure.

In some embodiments, such as that shown in FIG. 3, the device 200 comprises, downstream from the regulator 136, a gas/liquid separator 137, the gaseous evaporation gas being supplied to the bypass 150 and the liquid evaporation gas being supplied to the storage capacity 115.

The separator 137 is, for example, a separator drum.

The heat exchanger 135 is, for example, a finned or plate exchanger exchanging heat between the evaporation gas passing through the transfer pipe 125 and the LNG passing through the transfer pipe 130. The evaporation gas acts as hot fluid and the LNG as cold fluid, such that the outlet evaporation gas temperature is lower than the inlet evaporation gas temperature in the heat exchanger 135.

Preferably, the heat exchanger 135 is designed such that the evaporation gas is liquefied or cooled on exit from the heat exchanger 135 for defined LNG and evaporation gas flow rates.

The heat exchanger 135 is also designed, preferably, to heat the LNG to a defined temperature. The flow rate of gas passing through the transfer pipe 125 is adjusted as a function of said temperature. If the temperature of the LNG has to be raised, the gas transfer flow rate in the pipe 125 is increased.

Preferably, the LNG and evaporation gas circulate in opposite directions so as to optimize the heat exchange between the two fluids.

The storage capacity 115 is, for example, an evaporation gas storage volume designed to hold a predefined amount of LNG in a defined pressure range. The capacity 115 preferably comprises an inlet for liquefied evaporation gas. This inlet is, for example, a hole made in the storage capacity and configured to receive an injector for injecting liquefied evaporation gas into the volume. Such an injector is, for example, a nozzle or a one-way valve.

The capacity 115 has, for example, an operating pressure value between 7 and 9 bar.

Preferably, the operating pressure inside the storage capacity 115 is at least two bar less than the operating pressure inside the buffer tank 105.

The capacity 115 is equipped with an outlet for LNG, preferably in the lower portion, linked to the transfer pipe 130.

The transfer pipe 130 is linked to a connector whose nature depends on the type of third-party device connected to the device 200.

In some variants, the device 200 comprises a pump 116 configured to facilitate the transfer of LNG from the capacity 115 to the third-party device.

In some preferred embodiments, such as that shown in FIG. 3, the device 200 comprises, downstream from the heat exchanger 135, a bypass 150 of the transfer pipe 125 for liquefied or cooled evaporation gas in the heat exchanger, the provision of evaporation gas to the bypass being controlled as a function of a temperature measured by a temperature sensor 155 for the evaporation gas on exit from the heat exchanger.

In some preferred embodiments, such as that shown in FIG. 3, the device 200 comprises a first valve 160 on the bypass 150 and a second valve 165 on the evaporation gas transfer pipe 125 downstream from the bypass, the opening of the first or second valve being controlled as a function of the evaporation gas temperature measured.

When the evaporation gas has a temperature below a predefined threshold temperature, the first valve 160 is open and the second valve 165 is closed. Conversely, when the evaporation gas has a temperature above the predefined threshold temperature, the first valve 160 is closed and the second valve 165 is open.

In some preferred embodiments, such as that shown in FIG. 3, the device 200 comprises a member 170 for transferring liquefied evaporation gas from the buffer tank 105 to the LNG transfer pipe 130.

The member 170 is, for example, a valve controlled as a function of the pressure measured inside the storage tank 105 by a pressure sensor 171.

In some preferred embodiments, such as that shown in FIG. 3, the device 200 comprises:
an extraction line 205 for extracting evaporation gas inside the storage capacity 115;
a compressor 210 for compressing evaporation gas passing through the extraction line; and
a supply line 215 for supplying compressed evaporation gas to the buffer tank 105.

The line 205 is preferably linked to the upper portion of the storage capacity 115.

The compressor 210 is configured to, for example, bring the gas pressure to a value greater than 30 bar.

In some preferred embodiments, such as that shown in FIG. 3, the evaporation gas compressor 210 comprises the inlet 110 for evaporation gas suitable for receiving evaporation gas from a third-party device.

FIG. 2 shows, schematically, a particular embodiment of the method 300 that is the subject of the present invention. This method 300 for providing liquefied natural gas, referred to as LNG, is characterized in that it comprises:
a step 305 of storing evaporation gas from a third-party device in an evaporation gas buffer tank comprising an inlet for evaporation gas suitable for receiving evaporation gas from a third-party device;
a step 310 of transferring evaporation gas from the buffer tank to an LNG storage capacity;
downstream from the transfer step 310, a compression step 330 for compressing the evaporation gas;
a step 315 of exchanging heat between the transferred evaporation gas and the LNG transferred to a third-party device from the LNG storage capacity in order to liquefy or cool the evaporation gas;
a step 320 of storing LNG in the storage capacity;
a step 325 of transferring LNG from the storage capacity to a third-party device.

The operation of this method 200 is performed, for example, by utilizing devices 100 and 300, as described with reference to FIGS. 1 and 3, all the variants and embodiments of devices 100 and 300 can be transposed in the form of steps of the method 200.

1. A device for providing liquefied natural gas, referred to as LNG, comprising:
an evaporation gas buffer tank comprising an inlet for evaporation gas suitable for receiving evaporation gas from a third-party device;
a member for transferring evaporation gas from the buffer tank to an LNG storage capacity;
downstream from the transfer member, a compressor for compressing the evaporation gas;
an evaporation gas transfer pipe for transferring evaporation gas from the transfer member to the storage capacity;
the LNG storage capacity;
an LNG transfer pipe for transferring LNG from the storage capacity to a third-party device; and
a heat exchanger for exchanging heat between evaporation gas passing through the evaporation gas transfer pipe and LNG passing through the LNG transfer pipe, configured to liquefy or cool the evaporation gas.

2. A device according to claim 1, wherein the transfer member is a valve controlled as a function of a value of the pressure inside the buffer tank measured by a pressure sensor, or a discharge device.

3. A device according to claim 1, wherein the evaporation gas and the LNG circulate in opposite directions inside the heat exchanger.

4. A device according to claim 1, wherein the buffer tank has an operating pressure value at least two bar greater than the operating pressure value of the storage capacity.

5. A device according to claim 1, which comprises, downstream from the heat exchanger, a bypass of the transfer pipe for liquefied or cooled evaporation gas in the heat exchanger, the provision of evaporation gas to the bypass being controlled as a function of a temperature measured by a temperature sensor for the evaporation gas on exit from the heat exchanger.

6. A device according to claim 5, which comprises a first valve on the bypass and a second valve on the evaporation gas transfer pipe downstream from the bypass, the opening of the first or second valve being controlled as a function of the evaporation gas temperature measured.

7. A device according to claim 1, which comprises a member for transferring liquefied evaporation gas from the buffer tank to the LNG transfer pipe.

8. A device according to claim 1, which comprises:
an extraction line for extracting evaporation gas inside the storage capacity;
a compressor for compressing evaporation gas passing through the extraction line; and
a supply line for supplying compressed evaporation gas to the buffer tank.

9. A device according to claim 8, wherein the evaporation gas compressor comprises the inlet for evaporation gas suitable for receiving evaporation gas from a third-party device.

10. A device according to claim 1, which comprises a means for cooling the evaporation gas flow downstream from the transfer member.

11. A device according to claim 10, which comprises, downstream from the heat exchanger, a regulator for the gaseous flow, configured to expand the liquefied natural gas to a defined pressure.

12. A device according to claim 5, which comprises, downstream from the regulator, a gas/liquid separator, the gaseous evaporation gas being supplied to the bypass and the liquid evaporation gas being supplied to the storage capacity.

13. A method for providing liquefied natural gas, referred to as LNG, comprising:
a step of storing evaporation gas from a third-party device in an evaporation gas buffer tank comprising an inlet for evaporation gas suitable for receiving evaporation gas from a third-party device;
a step of transferring evaporation gas from the buffer tank to an LNG storage capacity;
downstream from the transfer step, a compression step for compressing the evaporation gas;
a step of exchanging heat between the transferred evaporation gas and the LNG transferred to a third-party device from the LNG storage capacity in order to liquefy or cool the evaporation gas;
a step of storing LNG in the storage capacity;
a step of transferring LNG from the storage capacity to a third-party device.
